(19) United States
(12) Patent Application Publication
(10) Pub. No.: US 2026/0361586 A1
(43) Pub. Date: Nov. 12, 2026

(54) RESOURCE BLOCK ALLOCATIONS FOR DISCRETE FOURIER TRANSFORM SPREAD ORTHOGONAL FREQUENCY DIVISION MULTIPLEXING TRANSMISSIONS

(71) Applicant: QUALCOMM Incorporated, San Diego, CA (US)

(72) Inventors: Vinayak SURESH, San Diego, CA (US); Jing SUN, San Diego, CA (US); Jing JIANG, San Diego, CA (US); Juergen CEZANNE, Ocean Township, NJ (US)

(21) Appl. No.: 19/669,774

(22) Filed: May 6, 2026

Related U.S. Application Data
(60) Provisional application No. 63/803,243, filed on May 9, 2025.

(51) Int. Cl. H04L 27/26

(52) U.S. Cl. CPC H04L 27/2636

(57) ABSTRACT

Various aspects of the present disclosure generally relate to wireless communication. In some aspects, a transmitter may receive a configuration that indicates a number of resource blocks (RBs) to be allocated for a discrete Fourier transform (DFT) spread orthogonal frequency division multiplexing (DFT-s-OFDM) transmission. The transmitter may detect that the number of RBs is not in accordance with a predefined format for an RB allocation restriction. The transmitter may select a DFT size that is greater than or equal to a number of resource elements (REs) associated with the number of RBs, wherein the DFT size is in accordance with a predefined format for a DFT size selection. The transmitter may puncture one or more post-DFT symbols. The transmitter may transmit the DFT-s-OFDM transmission based at least in part on the puncturing. Numerous other aspects are described.

### CROSS-REFERENCE TO RELATED APPLICATION

This Patent application claims priority to U.S. Provisional Patent Application No. 63/803,243, filed on May 9, 2025, entitled “RESOURCE BLOCK ALLOCATIONS FOR DISCRETE FOURIER TRANSFORM SPREAD ORTHOGONAL FREQUENCY DIVISION MULTIPLEXING TRANSMISSIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with resource block allocations for discrete Fourier transform spread orthogonal frequency division multiplexing transmission.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

In some implementations, an apparatus for wireless communication at a transmitter includes one or more memories; and one or more processors, coupled to the one or more memories, configured to cause the transmitter to: receive a configuration that indicates a number of resource blocks (RBs) to be allocated for a discrete Fourier transform (DFT) spread orthogonal frequency division multiplexing (DFT-s-OFDM) transmission; detect that the number of RBs is not in accordance with a predefined format for an RB allocation restriction; select a DFT size that is greater than or equal to a number of resource elements (REs) associated with the number of RBs, wherein the DFT size is in accordance with a predefined format for a DFT size selection; apply a puncturing to one or more post-DFT symbols, wherein a quantity associated with the one or more post-DFT symbols is based at least in part on a difference between the DFT size and the number of REs; and transmit the DFT-s-OFDM transmission based at least in part on the puncturing.

In some implementations, a method of wireless communication performed by a transmitter includes receiving a configuration that indicates a number of RBs to be allocated for a DFT-s-OFDM transmission; detecting that the number of RBs is not in accordance with a predefined format for an RB allocation restriction; selecting a DFT size that is greater than or equal to a number of REs associated with the number of RBs, wherein the DFT size is in accordance with a predefined format for a DFT size selection; puncturing one or more post-DFT symbols, wherein a quantity associated with the one or more post-DFT symbols is based at least in part on a difference between the DFT size and the number of REs; and transmitting the DFT-s-OFDM transmission based at least in part on the puncturing.

In some implementations, a non-transitory computer-readable medium storing a set of instructions for wireless communication includes one or more instructions that, when executed by one or more processors of a transmitter, cause the transmitter to: receive a configuration that indicates a number of RBs to be allocated for a DFT-s-OFDM transmission; detect that the number of RBs is not in accordance with a predefined format for an RB allocation restriction; select a DFT size that is greater than or equal to a number of REs associated with the number of RBs, wherein the DFT size is in accordance with a predefined format for a DFT size selection; puncture one or more post-DFT symbols, wherein a quantity associated with the one or more post-DFT symbols is based at least in part on a difference between the DFT size and the number of REs; and transmit the DFT-s-OFDM transmission based at least in part on the puncturing.

In some implementations, an apparatus for wireless communication includes means for receiving a configuration that indicates a number of RBs to be allocated for a DFT-s-OFDM transmission; means for detecting that the number of RBs is not in accordance with a predefined format for an RB allocation restriction; means for selecting a DFT size that is greater than or equal to a number of REs associated with the number of RBs, wherein the DFT size is in accordance with a predefined format for a DFT size selection; means for puncturing one or more post-DFT symbols, wherein a quantity associated with the one or more post-DFT symbols is based at least in part on a difference between the DFT size and the number of REs; and means for transmitting the DFT-s-OFDM transmission based at least in part on the puncturing.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example associated with resource block (RB) allocations for discrete Fourier transform spread orthogonal frequency division multiplexing transmission.

FIG. 3 is a diagram illustrating an example associated with a peak-to-average power ratio (PAPR) degradation.

FIG. 4 is a diagram illustrating an example associated with an impact of puncturing on PAPRs.

FIG. 5 is a diagram illustrating an example associated with a puncturing percentage for RB allocations.

FIG. 6 is a diagram illustrating an example associated with delta PAPR values for RB allocations.

FIG. 7 is a flowchart illustrating an example process performed, for example, by a transmitter.

FIG. 8 is a diagram of an example apparatus for wireless communication.

### DETAILED DESCRIPTION

Discrete Fourier transform (DFT) spread orthogonal frequency division multiplexing (OFDM) (DFT-s-OFDM) is a modulation technique in which data symbols are first transformed using a DFT, and then mapped onto subcarriers in an OFDM framework. Such a process may result in a single-carrier-like transmission with a lower peak-to-average power ratio (PAPR), as compared to only using OFDM, which may be beneficial for power-limited user equipments (UEs). DFT-s-OFDM may be particularly advantageous in uplink transmissions, as it reduces power amplifier requirements and improves battery life. DFT-s-OFDM may be used in wireless standards, such as New Radio (NR) and Long Term Evolution (LTE), to support high data rates and reliable communication.

Cyclic prefix (CP) OFDM (CP-OFDM) is a modulation technique in which a data stream is divided into multiple parallel sub-streams, where each sub-stream may be modulated onto a separate orthogonal subcarrier (e.g., using QAM). Before transmission, a CP may be added to each OFDM symbol, where the CP may be a repetition of an end portion of the symbol appended to its beginning. The CP may act as a guard interval, mitigating inter-symbol interference and allowing a receiver to effectively handle multipath propagation effects.

A number of resource blocks (RBs) that are able to be allocated for DFT-s-OFDM waveforms may be restricted. For example, the number of RBs that are able to be allocated for DFT-s-OFDM waveforms may be a multiple of 2, 3, or 5 (e.g., only a multiple of 2, 3, or 5). The number of RBs allocated may be of the form 2^{α}3^{β}5^{γ}, where α, β, and γ are non-negative integers, which means that the number of RBs may be any combination of the prime factors 2, 3, and 5, which may ensure that the allocation of RBs is an integer multiple of these numbers. A constraint of allocating resources in multiples of 2, 3, or 5 may be designed to optimize the use of a resource grid, which may define a structure of available resources in time and frequency. The resource grid may be organized in terms of OFDM symbols and subcarriers. For example, a supported allocation (in number of RBs) for DFT-s-OFDM may be 2, 3, 4, 5, 6, 8, 9, 10, 12, 14, 15, 20, 30, 40, and so on up to 273. Such a restriction on the number of RBs that are able to be allocated for DFT-s-OFDM waveforms may be in order to facilitate an efficient DFT and inverse DFT (IDFT) implementation in hardware, which may be part of a waveform generation and processing. Such a restriction may not be employed for CP-OFDM waveforms.

Restricting the number of RBs that are able to be allocated for DFT-s-OFDM waveforms to multiples of 2, 3, or 5 may have several potential downsides. Such a restriction may lead to reduced flexibility in terms of a resource allocation. The restriction may limit a granularity of resource allocation, which may lead to an inefficient use of an available spectrum. For example, when a needed number of RBs for a particular service does not align with the allowed multiple, an underutilization of resources or an over-provisioning of resources may result. The restriction may cause increased complexity in resource management. Network operators may need to manage and allocate resources more carefully to adhere to these constraints, which may complicate scheduling algorithms and increase computational overhead at network nodes, which may need to ensure that an allocation fits within the allowed multiples of RBs. When an exact number of required RBs cannot be allocated due to the restriction, additional scheduling cycles may be used to fulfill demand, which may potentially increase latency for certain transmissions. Applications with specific bandwidth requirements that do not align with the allowed multiples may experience suboptimal performance. For example, applications requiring a precise number of RBs for optimal operation may not obtain the exact allocation, which may lead to wasted resources or insufficient bandwidth. While the restriction to multiples of 2, 3, or 5 for DFT-s-OFDM waveforms may be intended to optimize hardware implementation and resource grid utilization, the restriction may lead to several inefficiencies, which may degrade an overall system performance.

Various aspects relate generally to RB allocations for DFT-s-OFDM waveforms. Some aspects more specifically relate to flexible RB allocation for DFT-s-OFDM waveforms using puncturing. In some examples, a transmitter, such as a UE, may receive a configuration that indicates a number of RBs to be allocated for a DFT-s-OFDM transmission. The number of RBs may be a flexible allocation of RBs for DFT-s-OFDM transmissions that is not restricted to being in accordance with a predefined format for an RB allocation restriction. The transmitter may detect that the number of RBs is not in accordance with the predefined format for the RB allocation restriction. The transmitter may select a DFT size that is greater than or equal to a number of resource elements (REs) associated with the number of RBs. The DFT size may be in accordance with a predefined format for a DFT size selection. The predefined format for the RB allocation restriction and the predefined format for the DFT size selection may define that the number of RBs is an integer multiple of 2, 3, or 5, or that the number of RBs allocated is of the form 2^{α}3^{β}5^{γ} or that the number of REs allocated is of the form 12×2^{α}3^{β}5^{γ}, where α, β, and γ are non-negative integers, and where 12 subcarriers per RB is assumed. The transmitter may select the DFT size such that a difference between the DFT size and the number of REs is smaller than differences between other possible DFT sizes and the number of REs. The transmitter may puncture one or more post-DFT symbols. A quantity associated with the one or more post-DFT symbols may be based at least in part on a difference between the DFT size and the number of REs. The transmitter may transmit, to a receiver, such as a network node, the DFT-s-OFDM transmission based at least in part on the puncturing.

In some aspects, the transmitter may apply a coding rate to obtain a number of coded constellation symbols. The number of coded constellation symbols may correspond to the DFT size. The transmitter may apply a DFT to the number of coded constellation symbols to obtain a plurality of post-DFT symbols. The transmitter may select the one or more post-DFT symbols that are punctured from the plurality of post-DFT symbols. The transmitter may apply the DFT in accordance with the DFT size. The transmitter may map a number of outputs to an inverse fast Fourier transform (FFT) (IFFT) for waveform generation, where the number of outputs may correspond to the number of REs. The transmitter may apply the puncturing to the plurality of post-DFT symbols to obtain a continuous set of non-punctured post-DFT symbols. The transmitter may apply the puncturing to one end of the plurality of post-DFT symbols or from two ends of the plurality of post-DFT symbols in order to obtain the continuous set of non-punctured post-DFT symbols. The transmitter may not transmit the one or more post-DFT symbols that are punctured.

Particular aspects of the subject matter described in this disclosure can be implemented to realize one or more of the following potential advantages. In some examples, by configuring the transmitter to appropriately select the DFT size and puncture a certain number of symbols based at least in part on the DFT size, the described techniques can be used to implement the flexible RB allocation for DFT-s-OFDM transmissions. The DFT-s-OFDM transmissions may not be restricted to the predefined format for the RB allocation restriction, such as the form 2^{α}3^{β}5^{γ} or 12×2^{α}3^{β}5^{γ}. A network may allow an unrestricted number of RBs to be allocated for DFT-s-OFDM transmissions. For example, the number of RBs may be anywhere between 1 RB and 273 RBs for a 100 megahertz (MHz) channel. An ability to appropriately select the DFT size in accordance with the predefined format for the DFT size selection, even when the number of RBs does not follow the predefined format for the RB allocation restriction, may facilitate an efficient DFT implementation in hardware, similar to when such a restriction is in place. When the number of RBs does not follow the predefined format for the RB allocation restriction, a PAPR degradation as compared to when the number of RBs does follow the predefined format for the RB allocation restriction may be negligible. As a result, an ability to support the flexible RB allocation for DFT-s-OFDM transmissions may improve an overall system performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mm Wave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

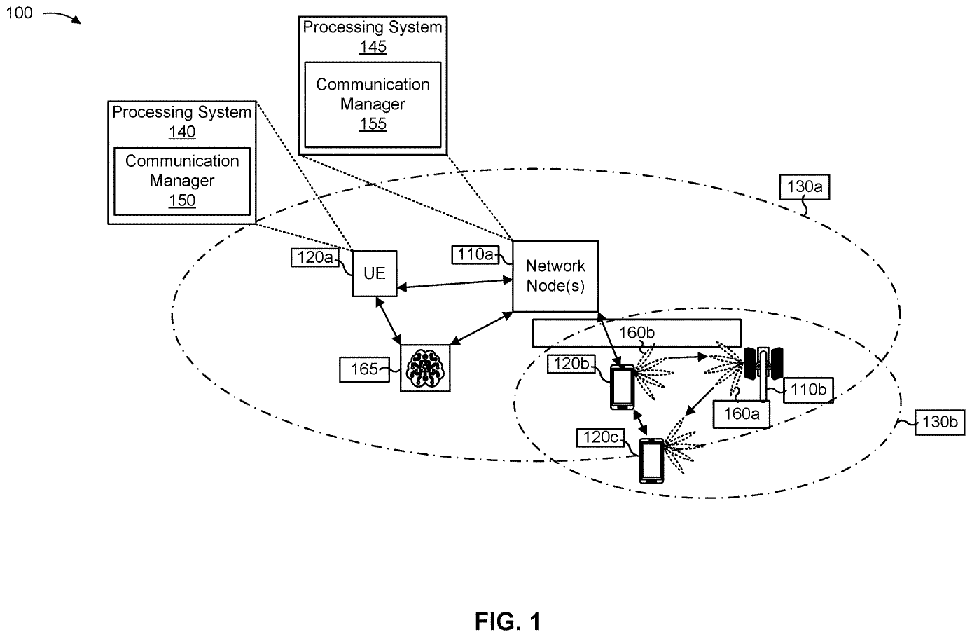

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHZ), FR2 (24.25 GHz through 52.6 GHZ), FR3 (7.125 GHz through 24.25 GHz), FR4a or FR4-1 (52.6 GHz through 71 GHz), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as an FFT, an IFFT, beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, RBs, and REs), and spatial domain resources (for example, particular transmit directions or beams).

Frequency domain resources may be subdivided into bandwidth parts (BWPs). A BWP may be a block of frequency domain resources (for example, a continuous set of RBs within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (L1), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a DFT-s-OFDM waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, a transmitter (e.g., the UE 120 or the network node 110) may include a communication manager 150 or a communication manager 155. As described in more detail elsewhere herein, the communication manager 150 or the communication manager 155 may receive a configuration that indicates a number of RBs to be allocated for a DFT-s-OFDM transmission; detect that the number of RBs is not in accordance with a predefined format for an RB allocation restriction; select a DFT size that is greater than or equal to a number of REs associated with the number of RBs, wherein the DFT size is in accordance with a predefined format for a DFT size selection; puncture one or more post-DFT symbols, wherein a quantity associated with the one or more post-DFT symbols is based at least in part on a difference between the DFT size and the number of REs; and transmit the DFT-s-OFDM transmission based at least in part on the puncturing. Additionally, or alternatively, the communication manager 150 or the communication manager 155 may perform one or more other operations described herein.

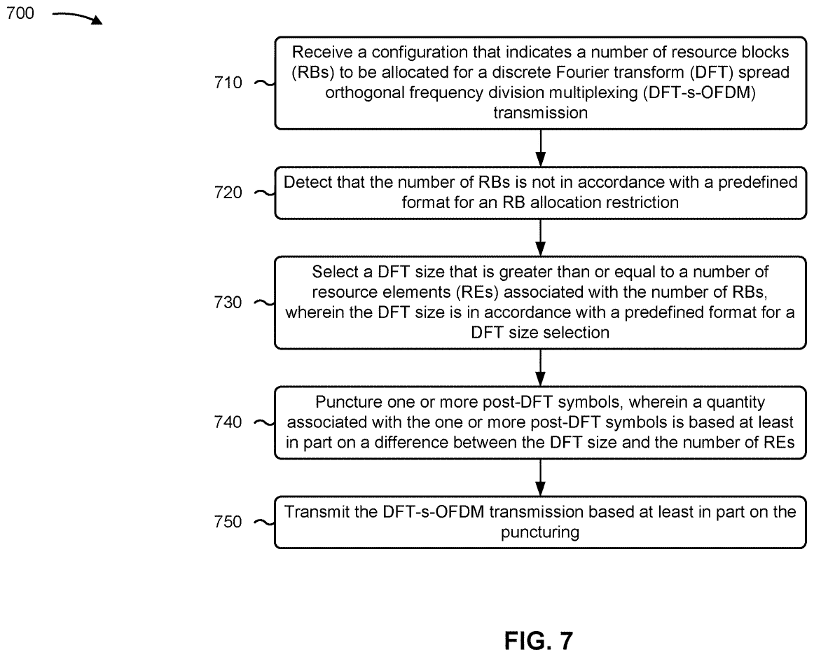

The network node 110, the processing system 145 of the network node 110, the UE 120, the processing system 140 of the UE 120, or any other component(s) of FIG. 1 may implement one or more techniques or perform one or more operations associated with RB allocations for DFT-s-OFDM transmissions, as described in more detail elsewhere herein. For example, the processing system 145 of the network node 110, or the processing system 140 of the UE 120 may perform or direct operations of, for example, process 700 of FIG. 7, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 700 of FIG. 7, or other processes as described herein. In some examples, executing instructions may include running the instructions, converting the instructions, compiling the instructions, or interpreting the instructions, among other examples.

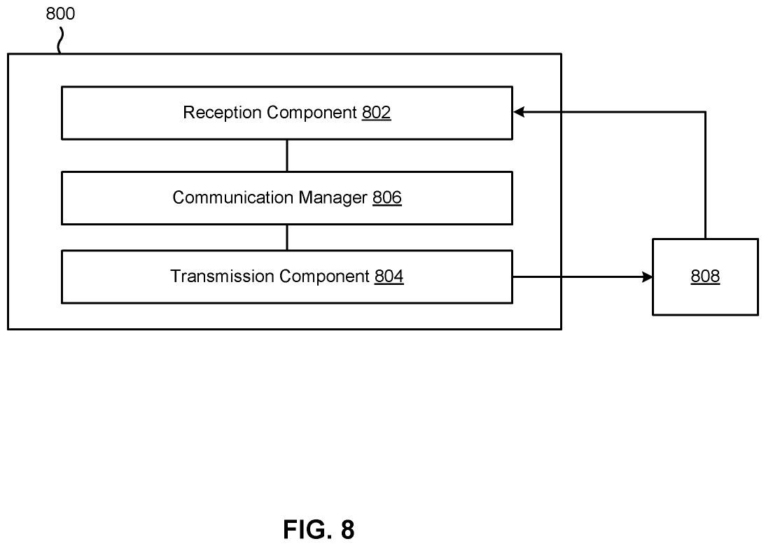

In some aspects, a transmitter (e.g., the UE 120 or the network node 110) includes means for receiving a configuration that indicates a number of RBs to be allocated for a DFT-s-OFDM transmission; means for detecting that the number of RBs is not in accordance with a predefined format for an RB allocation restriction; means for selecting a DFT size that is greater than or equal to a number of REs associated with the number of RBs, wherein the DFT size is in accordance with a predefined format for a DFT size selection; means for puncturing one or more post-DFT symbols, wherein a quantity associated with the one or more post-DFT symbols is based at least in part on a difference between the DFT size and the number of REs; or means for transmitting the DFT-s-OFDM transmission based at least in part on the puncturing. In some aspects, the means for the transmitter to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples. In some aspects, the means for the transmitter to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

As indicated above, FIG. 1 is provided as an example. Other examples may differ from what is described with regard to FIG. 1.

DFT-s-OFDM is a modulation technique used in wireless communication systems to enhance signal robustness and spectral efficiency. DFT-s-OFDM may combine the principles of DFT and OFDM, where data symbols may be first transformed using a DFT, and then mapped onto subcarriers in an OFDM framework. Such a process may result in a single-carrier-like transmission with a lower PAPR, as compared to only using OFDM, which may be beneficial for power-limited UEs. DFT-s-OFDM may be particularly advantageous in uplink transmissions, as it reduces power amplifier requirements and improves battery life in UEs. DFT-s-OFDM may be used in wireless standards, such as NR and LTE, to support high data rates and reliable communication.

CP-OFDM is a modulation technique in wireless communication systems, known for its robustness against multipath interference and its efficient use of available spectrum. In CP-OFDM, a data stream may be divided into multiple parallel sub-streams, where each sub-stream may be modulated onto a separate orthogonal subcarrier (e.g., using QAM). Before transmission, a CP may be added to each OFDM symbol, where the CP may be a repetition of an end portion of the symbol appended to its beginning. The CP may act as a guard interval, mitigating inter-symbol interference and allowing a receiver to effectively handle multipath propagation effects. A CP-OFDM waveform may be generated by applying an IFFT to modulated subcarriers, and then converting a frequency domain signal into a time domain signal. After reception, the CP may be removed and an FFT may be applied to convert the signal back to the frequency domain for demodulation and data recovery.

A number of RBs that are able to be allocated for DFT-s-OFDM waveforms may be restricted. For example, the number of RBs that are able to be allocated for DFT-s-OFDM waveforms may be a multiple of 2, 3, or 5 (e.g., only a multiple of 2, 3, or 5). The number of RBs allocated may be of the form 2^{α}3^{β}5^{γ}, where α, β, and γ are non-negative integers, which means that the number of RBs may be any combination of the prime factors 2, 3, and 5, which may ensure that the allocation of RBs is an integer multiple of these numbers. A constraint of allocating resources in multiples of 2, 3, or 5 may be designed to optimize the use of a resource grid, which may define a structure of available resources in time and frequency. The resource grid may be organized in terms of OFDM symbols and subcarriers. For example, a supported allocation (in number of RBs) for DFT-s-OFDM may be 2, 3, 4, 5, 6, 8, 9, 10, 12, 14, 15, 20, 30, 40, and so on up to 273. In other words, a supported RB size may be 2, 3, 4, and so on up to 273. Such a restriction on the number of RBs that are able to be allocated for DFT-s-OFDM waveforms may be in order to facilitate an efficient DFT and IDFT implementation in hardware, which may be part of a waveform generation and processing. Such a restriction may not be employed for CP-OFDM waveforms.

DFT-s-OFDM may be associated with a lower PAPR as compared to CP-OFDM, which may be based at least in part on the single-carrier property associated with DFT-s-OFDM. The lower PAPR may enable a better power amplifier efficiency and operation closer to PA saturation, as compared to CP-OFDM, which may help to improve coverage. DFT-s-OFDM may be supported in NR systems for uplink transmissions. DFT-s-OFDM may be supported for downlink transmissions in future wireless standards.

Restricting the number of RBs that are able to be allocated for DFT-s-OFDM waveforms to multiples of 2, 3, or 5 may have several potential downsides. Such a restriction may lead to reduced flexibility in terms of a resource allocation. The restriction may limit a granularity of resource allocation, which may lead to an inefficient use of an available spectrum. For example, when a needed number of RBs for a particular service does not align with the allowed multiple, an underutilization of resources or an over-provisioning of resources may result. The restriction may cause increased complexity in resource management. Network operators may need to manage and allocate resources more carefully to adhere to these constraints, which may complicate scheduling algorithms and increase computational overhead at network nodes, which may need to ensure that an allocation fits within the allowed multiples of RBs. When an exact number of required RBs cannot be allocated due to the restriction, additional scheduling cycles may be used to fulfill demand, which may potentially increase latency for certain transmissions. Applications with specific bandwidth requirements that do not align with the allowed multiples may experience suboptimal performance. For example, applications requiring a precise number of RBs for optimal operation may not obtain the exact allocation, which may lead to wasted resources or insufficient bandwidth. While the restriction to multiples of 2, 3, or 5 for DFT-s-OFDM waveforms may be intended to optimize hardware implementation and resource grid utilization, the restriction may lead to several inefficiencies, which may degrade an overall system performance.

In various aspects of techniques and apparatuses described herein, a transmitter, such as a UE, may receive a configuration that indicates a number of RBs to be allocated for a DFT-s-OFDM transmission. The number of RBs may be a flexible allocation of RBs for DFT-s-OFDM transmissions that is not restricted to being in accordance with a predefined format for an RB allocation restriction. The transmitter may detect that the number of RBs is not in accordance with the predefined format for the RB allocation restriction. The transmitter may select a DFT size that is greater than or equal to a number of REs associated with the number of RBs. The DFT size may be in accordance with a predefined format for a DFT size selection. The predefined format for the RB allocation restriction and the predefined format for the DFT size selection may define that the number of RBs is an integer multiple of 2, 3, or 5, or that the number of RBs allocated is of the form 2^{α}3^{β}5^{γ} or that the number of REs allocated is of the form 12×2^{α}3^{β}5^{γ}, where α, β, and γ are non-negative integers, and where 12 subcarriers per RB is assumed. The transmitter may select the DFT size such that a difference between the DFT size and the number of REs is smaller than differences between other possible DFT sizes and the number of REs. The transmitter may puncture one or more post-DFT symbols. A quantity associated with the one or more post-DFT symbols may be based at least in part on a difference between the DFT size and the number of REs. The transmitter may transmit, to a receiver, such as a network node, the DFT-s-OFDM transmission based at least in part on the puncturing.

In some aspects, the transmitter may apply a coding rate to obtain a number of coded constellation symbols. The number of coded constellation symbols may correspond to the DFT size. The transmitter may apply a DFT to the number of coded constellation symbols to obtain a plurality of post-DFT symbols. The transmitter may select the one or more post-DFT symbols that are punctured from the plurality of post-DFT symbols. The transmitter may apply the DFT in accordance with the DFT size. The transmitter may map a number of outputs to an IFFT for waveform generation, where the number of outputs may correspond to the number of REs. The transmitter may apply the puncturing to the plurality of post-DFT symbols to obtain a continuous set of non-punctured post-DFT symbols. The transmitter may apply the puncturing to one end of the plurality of post-DFT symbols or from two ends of the plurality of post-DFT symbols to obtain the continuous set of non-punctured post-DFT symbols. The transmitter may not transmit the one or more post-DFT symbols that are punctured.

In some aspects, by configuring the transmitter to appropriately select the DFT size and puncture a certain number of symbols based at least in part on the DFT size, flexible RB allocation may be implemented for DFT-s-OFDM transmissions. The DFT-s-OFDM transmissions may not be restricted to the predefined format for the RB allocation restriction, such as the form 2^{α}3^{β}5^{γ} or 12×2^{α}3^{β}5^{γ}. A network may allow an unrestricted number of RBs to be allocated for DFT-s-OFDM transmissions. For example, the number of RBs may be anywhere between 1 RB and 273 RBs for a 100 megahertz (MHz) channel. An ability to appropriately select the DFT size in accordance with the predefined format for the DFT size selection, even when the number of RBs does not follow the predefined format for the RB allocation restriction, may facilitate an efficient DFT implementation in hardware, similar to when such a restriction is in place. When the number of RBs does not follow the predefined format for the RB allocation restriction, a PAPR degradation as compared to when the number of RBs does follow the predefined format for the RB allocation restriction may be negligible. As a result, an ability to support the flexible RB allocation for DFT-s-OFDM transmissions may improve an overall system performance.

In some aspects, to enhance flexibility, an RB allocation size restriction may be removed from DFT-s-OFDM, which may further strengthen DFT-s-OFDM.

Removing the RB allocation size restriction may prevent an underutilization of resources or an over-utilization of resources, which may be due to increased flexibility in resource allocations. An ability to allocate an exact number of RBs, without restricting the number of RBs to being a multiple of 2, 3, or 5, may help network operators manage and allocate resources more efficiently without such constraints. The ability to allocate the exact number of RBs may prevent additional scheduling cycles. The ability to allocate the exact number of RBs may be useful for applications requiring a precise number of RBs for optimal operation. Thus, removing the RB allocation size restriction to DFT-s-OFDM waveforms may improve an overall system performance.

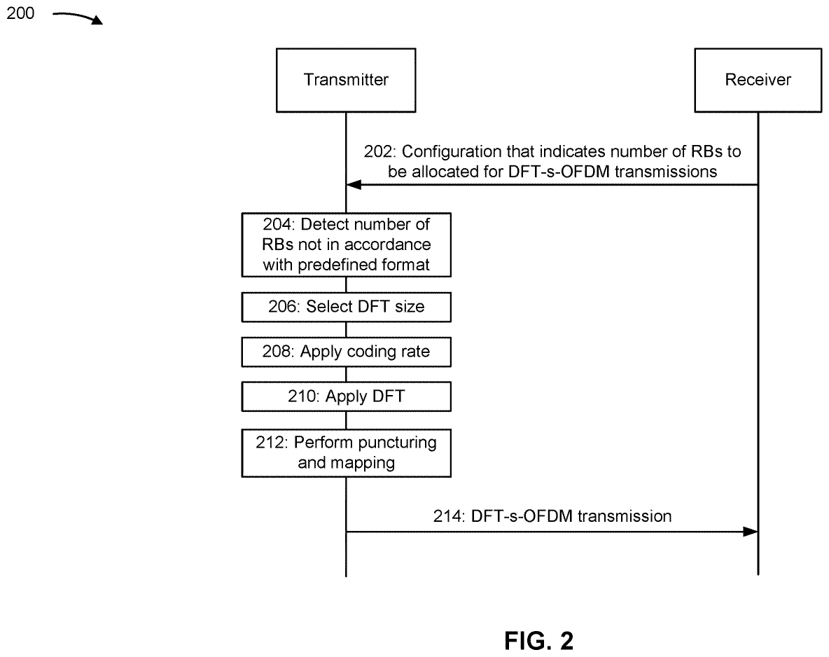

FIG. 2 is a diagram illustrating an example 200 associated with RB allocations for DFT-s-OFDM transmissions. As shown in FIG. 2, example 200 includes communication between a transmitter (e.g., UE 120 or network node 110) and a receiver (e.g., network node 110 or UE 120). In some aspects, the transmitter and the receiver node may be included in a wireless network, such as wireless network 100.

As shown by reference number 202, the transmitter may receive, from the receiver, a configuration that indicates a number of RBs to be allocated for a DFT-s-OFDM transmission. The number of RBs may be a flexible allocation of RBs for DFT-s-OFDM transmissions that is not restricted to being in accordance with a predefined format for an RB allocation restriction. The transmitter may receive the configuration via RRC signaling. In one example, for a 100 MHz, the number of RBs may range between 1 RB and 273 RBs.

As shown by reference number 204, the transmitter may detect, based at least in part on the configuration, that the number of RBs is not in accordance with the predefined format for the RB allocation restriction. The predefined format for the RB allocation restriction may define that the number of RBs is an integer multiple of 2, 3, or 5. The predefined format for the RB allocation restriction may define that the number of RBs is of a form 2^{α}3^{β}5^{γ} or 12×2^{α}3^{β}5^{γ}, where α, β, and γ are non-negative integers. As example, when the number of RBs is 7 (e.g., a number that is not of the form 2^{α}3^{β}5^{γ}), the transmitter may detect that the number of RBs is not in accordance with the predefined format for the RB allocation restriction.

As shown by reference number 206, the transmitter may select a DFT size. The DFT size may indicate a number of samples or data points in an input sequence that are transformed from a time domain to a frequency domain. The transmitter may select a DFT size that is greater than or equal to a number of REs associated with the number of RBs. The DFT size may be in accordance with a predefined format for a DFT size selection. The predefined format for the DFT size selection may define that the number of RBs is an integer multiple of 2, 3, or 5. The predefined format for the DFT size selection may define that the number of RBs is of a form 2^{α}3^{β}5^{γ} or 12×2^{α}3^{β}5^{γ} where α, β, and γ are non-negative integers. The transmitter may select the DFT size such that a difference between the DFT size and the number of REs is smaller than differences between other possible DFT sizes and the number of REs.

As shown by reference number 208, the transmitter may apply a coding rate to obtain a number of coded constellation symbols. The number of coded constellation symbols may correspond to the DFT size. For example, the number of coded constellation symbols may correspond to a number of REs that corresponds to the DFT size.

As shown by reference number 210, the transmitter may apply a DFT to the number of coded constellation symbols to obtain a plurality of post-DFT symbols. The transmitter may apply the DFT in accordance with the DFT size. The transmitter may apply the DFT in order to transform the input sequence from the time domain to the frequency domain. After the DFT is applied, the transmitter may obtain post-DFT symbols.

As shown by reference number 212, the transmitter may puncture the one or more post-DFT symbols. The transmitter may select the one or more post-DFT symbols to be punctured from the plurality of post-DFT symbols. A quantity associated with the one or more post-DFT symbols may be based at least in part on a difference between the DFT size and the number of REs. The transmitter may map a number of outputs to an IFFT for waveform generation, where the number of outputs may correspond to the number of REs. The transmitter may apply the puncturing to the plurality of post-DFT symbols to obtain a continuous set of non-punctured post-DFT symbols. The transmitter may apply the puncturing to one end of the plurality of post-DFT symbols or from two ends of the plurality of post-DFT symbols to obtain the continuous set of non-punctured post-DFT symbols.

As shown by reference number 214, the transmitter may transmit, to the receiver, the DFT-s-OFDM transmission based at least in part on the puncturing. The transmitter may not transmit the one or more post-DFT symbols that are punctured. The DFT-s-OFDM transmission may be based at least in part on the RB allocation that does not correspond to the predefined format for the RB allocation restriction. A PAPR degradation associated with the DFT-s-OFDM transmission may be negligible as compared to a DFT-s-OFDM transmission that does correspond to the predefined format for the RB allocation restriction.

In some aspects, an unrestricted number of RBs may be allocated for the DFT-s-OFDM transmission. The unrestricted number of RBs may not be subjected to a limitation that a number of RBs is to be a multiple of 2, 3, or 5. For example, in a channel (e.g., 100 MHz 30 kilohertz (KHz) channel), the number of RBs that are able to be allocated for the DFT-s-OFDM transmission may be between 1 RB and 273 RBs (inclusive).

In some aspects, the DFT size (L) may indicate a number of samples or data points in an input sequence that are transformed from a time domain to a frequency domain. The DFT size may affect a frequency resolution, a computational complexity, and a periodicity of a resulting frequency domain representation. The DFT size may be selected based at least in part on specific requirements of an application, characteristics of the input sequence, and available computational resources. From a hardware point of view, the DFT size being of the form 2^{α}3^{β}5^{γ} may be preferred because such a DFT size may facilitate an efficient DFT/IDFT implementation in the hardware.

In some aspects, the number of allocated REs (M) may not be of the form 2^{α}3^{β}5^{γ}, where the number of allocated REs is calculated by multiplying a number of RBs by 12 (e.g., M=number of RBs×12). When the number of allocated REs is not of the form 2^{α}3^{β}5^{γ}, the UE may select DFT-size L≥M to be of the form L=2^{α}3^{β}5^{γ} (e.g., a smallest such number) or of the form L=2^{α}3^{β}5^{γ}×12. The UE may encode with a smaller coding rate, such that a number of coded constellation symbols corresponds to L allocated REs. The UE may apply the DFT in accordance with size L (e.g., L-DFT), and post L-DFT, the UE may puncture Q=L−M post-DFT symbols and map M outputs to an IFFT for waveform generation. The UE may perform a puncturing in a manner such that remaining symbols may form one continuous set or chunk. The puncturing may be done from only one end, or the puncturing may be done equally or unequally on both ends.

In one example, the UE may perform an encoding in accordance with:

$$[ \begin{matrix}{s}_{0}^{′} \\ ⋮ \\ {s}_{M - 1}^{′}\end{matrix} ] \to [ \begin{matrix}{s}_{0} \\ {s}_{1} \\ ⋮ \\ {s}_{L - 1}\end{matrix} ] \to L - DFT \to [ \begin{matrix}{S}_{0} \\ {S}_{1} \\ ⋮ \\ {S}_{L - 1}\end{matrix} ] \to [ \begin{matrix}{S}_{Q} \\ {S}_{Q + 1} \\ ⋮ \\ {S}_{L - 1}\end{matrix} ] ,$$

where the UE may obtain symbols

$${s}_{0}^{′} , … {s}_{M - 1}^{′} .$$

The UE may adjust a coding rate (e.g., apply the smaller coding rate) to obtain the number of coded constellation symbols s₀, s₁, . . . s_{L-1}. The UE may apply the L-DFT in order to obtain symbols s₀, s₁, . . . , s_{L-1}. The UE may perform puncturing on Q symbols (e.g., Q=L−M) to obtain the post-DFT symbols S_{Q}, S_{Q+1}, . . . S_{L-1}, where the UE may then map the M outputs to the IFFT for the waveform generation.

As an example, the UE (transmitter) may be allocated with 11 RBs, which corresponds to 132 REs. In this example, 11 is not of the form 2^{α}3^{β}5^{γ}. In a first option, the UE may select a DFT size of 135 (e.g., 135=3³×5). In the first option, 135 may be the closest number that is greater than or equal to 132 that satisfies the form of 2^{α}3^{β}5^{γ}. In the first option, 3 post-DFT outputs (e.g., 3=135−132) may be punctured and not transmitted by the UE. A statistical PAPR (in dB) may be calculated for quadrature phase-shift keying (QPSK). The statistical PAPR may be for a DFT size 132 with no puncturing versus a DFT size 135 with 3 post-DFT output punctured, and a PAPR degradation between the DFT size 132 with no puncturing and the DFT size 135 with 3 post-DFT output punctured may be negligible. In a second option, the UE may select a DFT size that corresponds to 12 RBs instead of 11 RBs. In this example, the DFT size that corresponds to 12 RBs is a DFT size of 144. In the second option, the DFT size of 144 is of the form 2^{α}3^{β}5^{γ} and is of the form 2^{α}3^{β}5^{γ}×12. In the second option, 12 post-DFT outputs (e.g., 12=144−132) may be punctured and not transmitted by the UE.

In some aspects, due to puncturing, the PAPR of a DFT-s-OFDM waveform may be affected. For example, for a 100 RB allocation and when puncturing is performed symmetrically from both sides, increasing a puncturing percentage from 0% to 10% may cause the PAPR at a 1% cumulative distribution function (CCDF) may degrade by up to 0.3 dB. For example, puncturing at 0%, puncturing at 1%, puncturing at 2%, puncturing at 5%, or puncturing at 10% may lead to progressively higher PAPR degradations. When a number of allocated RBs is not of the form 2^{α}3^{β}5^{γ}, where a number of allocated REs is M=number of RBs×12, a DFT-size L≥M may be selected that that L-Mis as small as possible.

In some aspects, the UE may select a DFT-size L≥M of the form L=2^{α}3^{β}5^{γ}, such that L-M is as small as possible. In some aspects, the UE may select the DFT-size L≥M, such that L is of the form L=12×2^{α}3^{β}5^{γ} and L−M is as small as possible. In this example, the selected DFT-size may correspond to an allowed RB allocation. Selecting the DFT-size L≥M of the form L=2^{α}3^{β}5^{γ} may result in a lower puncturing percentage, which may keep a PAPR growth more contained as compared to selecting the DFT-size L≥M of the form L=12×2^{α}3^{β}5^{γ}. The UE may perform the puncturing in a manner that results in one continuous set or chunk of symbols. The puncturing may be done from only one end of a plurality of post-DFT outputs, or the puncturing may be done equally/unequally on both ends of the plurality of post-DFT outputs.

In some aspects, given an allocation of X RBs, the UE may select a DFT size to be a largest composite number of the form 2^{α}3^{β}5^{γ} that is greater than or equal to M=X×12. A difference (if any) between the DFT size selected (of the form 2^{α}3^{β}5^{γ}) and the number of allocated REs (M=X×12) may be punctured post-DFT. For each RB allocation from 1 to 272, a puncturing percentage may be calculated in terms of a selected DFT size minus a number of allocated REs, which may be divided by the selected DFT size. For the RB allocation ranging from 1 to 272, the puncturing percentage may range from a minimum of 0% to a maximum of approximately 7%. For example, an RB allocation of 9 may result in a puncturing percentage of 0% because no allocated REs may be punctured post-DFT. The puncturing percentage may be relatively low, which may keep a PAPR impact to be minimal.

In some aspects, a PAPR delta may be calculated between a punctured (symmetric puncturing) DFT-s-OFDM waveform versus a regular DFT-s-OFDM waveform. In the regular DFT-s-OFDM waveform, a DFT size may be a number of allocated RBs multiplied by 12 (e.g., an unrestricted DFT size). The regular DFT-s-OFDM waveform may be associated with QPSK modulation. The PAPR delta (in dB) may be at 1% CCDF. Alternatively, the PAPR delta (in dB) may be at 10% CCDF (QPSK). The PAPR delta may be calculated for each RB allocation from 1 to 272.

In some aspects, certain RB allocations may be excluded when a PAPR growth is higher than a defined threshold. For example, certain RB allocations that result in the PAPR growth exceeding the defined threshold may not be used by the UE. In some aspects, certain RB allocations may be excluded when another metric, such as a cubic metric, satisfies a defined threshold. In some aspects, for DFT-s-OFDM with pulse shaping or frequency domain spectral shaping (FDSS), puncturing of edge REs may have less impact on the PAPR delta or an error vector magnitude (EVM) growth.

As indicated above, FIG. 2 is provided as an example. Other examples may differ from what is described with regard to FIG. 2.

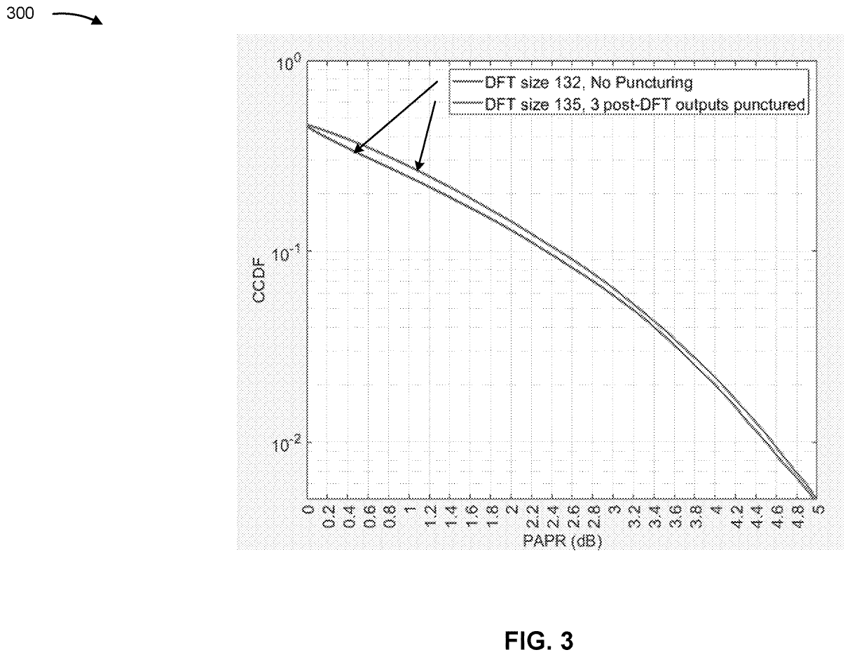

FIG. 3 is a diagram illustrating an example 300 associated with a PAPR degradation.

As shown in FIG. 3, a UE (transmitter) may be allocated with 11 RBs, which corresponds to 132 REs. In this example, 11 is not of the form 2^{α}3^{β}5^{γ}. The UE may select a DFT size of 135 (e.g., 135=3³×5). 135 may be the closest number that is greater than or equal to 132 that satisfies the form of 2^{α}3^{β}5^{γ}. 3 post-DFT outputs (e.g., 3=135−132) may be punctured and not transmitted by the UE. A statistical PAPR (in dB) may be calculated for QPSK. The statistical PAPR may be for a DFT size 132 with no puncturing versus a DFT size 135 with 3 post-DFT output punctured, and a PAPR degradation between the DFT size 132 with no puncturing and the DFT size 135 with 3 post-DFT output punctured may be negligible.

As indicated above, FIG. 3 is provided as an example. Other examples may differ from what is described with regard to FIG. 3.

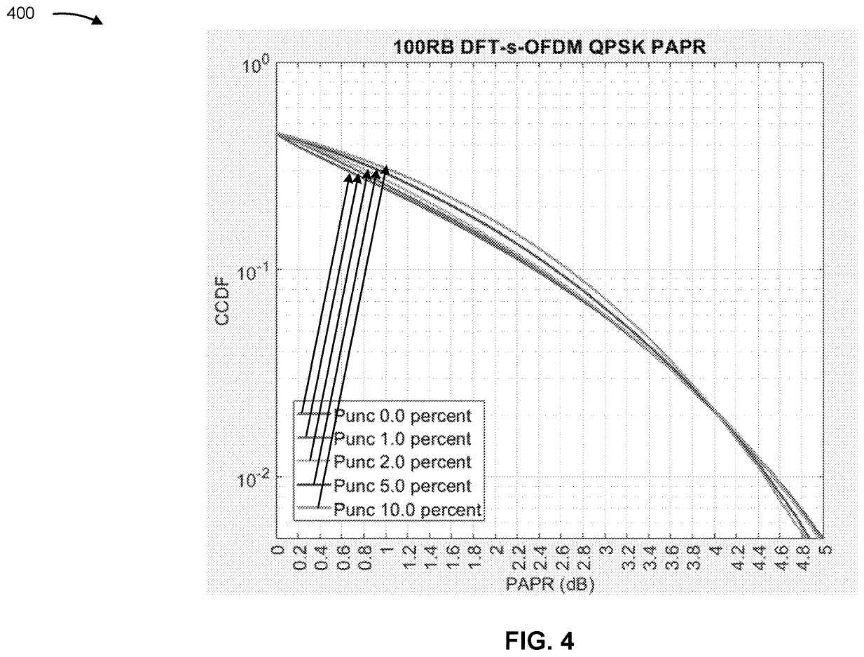

FIG. 4 is a diagram illustrating an example 400 associated with an impact of puncturing on PAPRs.

As shown in FIG. 4, for a 100 RB allocation and when puncturing is performed symmetrically from both sides, increasing a puncturing percentage from 0% to 10% may cause the PAPR at a 1% CCDF may degrade by up to 0.3 dB. For example, puncturing at 0%, puncturing at 1%, puncturing at 2%, puncturing at 5%, or puncturing at 10% may lead to progressively higher PAPR degradations.

As indicated above, FIG. 4 is provided as an example. Other examples may differ from what is described with regard to FIG. 4.

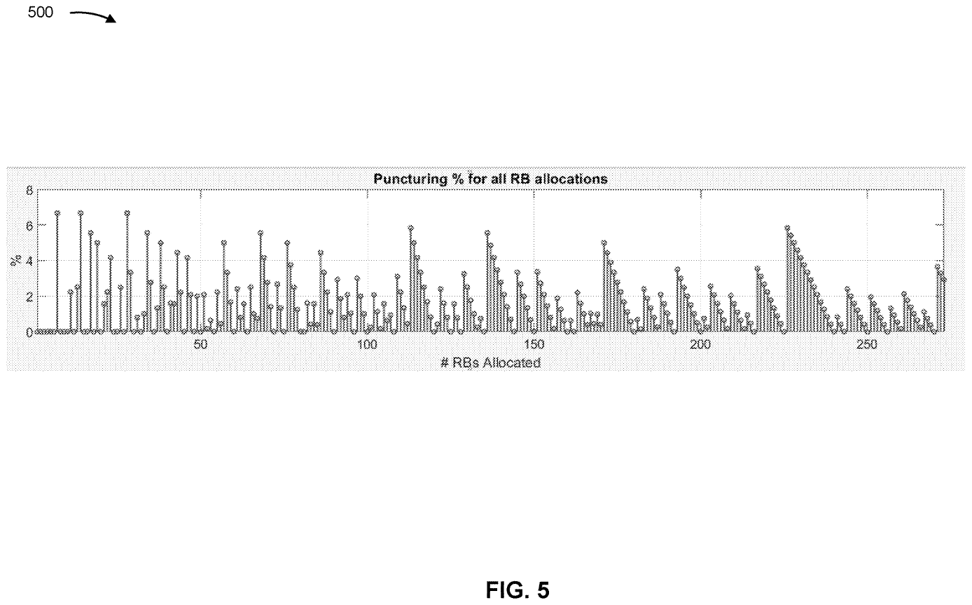

FIG. 5 is a diagram illustrating an example 500 associated with a puncturing percentage for RB allocations.

As shown in FIG. 5, a difference (if any) between a DFT size selected (of the form 2^{α}3^{β}5^{γ}) and a number of allocated REs (M=X×12) may result in outputs that are to be punctured post-DFT. For each RB allocation from 1 to 272, a puncturing percentage may be calculated in terms of a selected DFT size minus a number of allocated REs, which may be divided by the selected DFT size. For the RB allocation ranging from 1 to 272, the puncturing percentage may range from a minimum of 0% to a maximum of approximately 7%. For example, an RB allocation of 9 may result in a puncturing percentage of 0% because no allocated REs may be punctured post-DFT. The puncturing percentage may be relatively low, which may keep a PAPR impact to be minimal.

As indicated above, FIG. 5 is provided as an example. Other examples may differ from what is described with regard to FIG. 5.

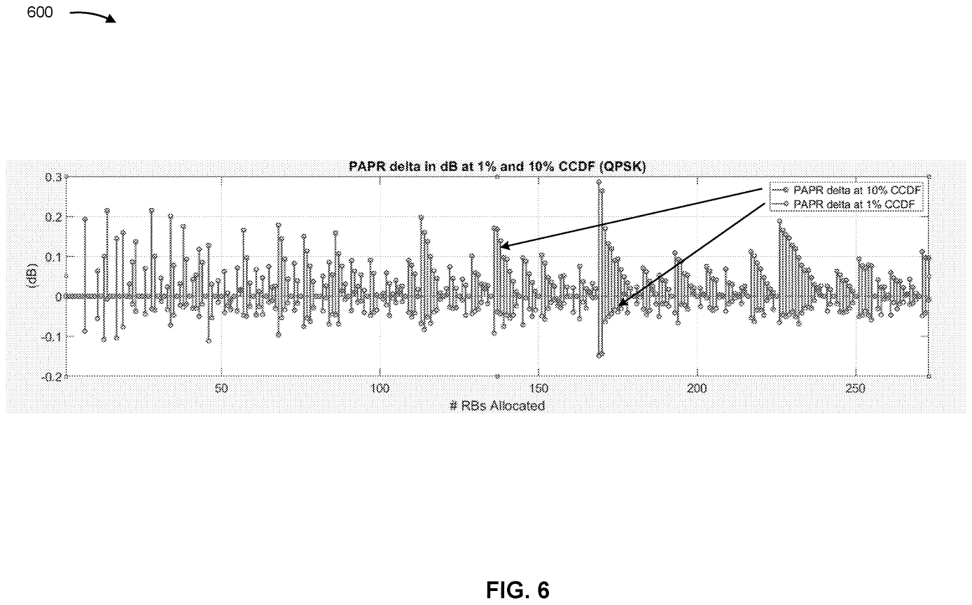

FIG. 6 is a diagram illustrating an example 600 associated with delta PAPR values for RB allocations.

As shown in FIG. 6, a PAPR delta may be calculated between a punctured (symmetric puncturing) DFT-s-OFDM waveform versus a regular DFT-s-OFDM waveform. In the regular DFT-s-OFDM waveform, a DFT size may be a number of allocated RBs multiplied by 12 (e.g., an unrestricted DFT size). The regular DFT-s-OFDM waveform may be associated with QPSK modulation. The PAPR delta (in dB) may be at 1% CCDF. Alternatively, the PAPR delta (in dB) may be at 10% CCDF (QPSK). The PAPR delta may be calculated for each RB allocation from 1 to 272.

As indicated above, FIG. 6 is provided as an example. Other examples may differ from what is described with regard to FIG. 6.

FIG. 7 is a diagram illustrating an example process 700 performed, for example, at a transmitter or an apparatus of a transmitter. Example process 700 is an example where the apparatus or the transmitter (e.g., UE 120 or network node 110) performs operations associated with RB allocations for DFT-s-OFDM transmissions.

As shown in FIG. 7, in some aspects, process 700 may include receiving a configuration that indicates a number of RBs to be allocated for a DFT-s-OFDM transmission (block 710). For example, the transmitter (e.g., using reception component 802 or communication manager 806, depicted in FIG. 8) may receive a configuration that indicates a number of RBs to be allocated for a DFT-s-OFDM transmission, as described above.

As further shown in FIG. 7, in some aspects, process 700 may include detecting that the number of RBs is not in accordance with a predefined format for an RB allocation restriction (block 720). For example, the transmitter (e.g., using communication manager 806, depicted in FIG. 8) may detect that the number of RBs is not in accordance with a predefined format for an RB allocation restriction, as described above.

As further shown in FIG. 7, in some aspects, process 700 may include selecting a DFT size that is greater than or equal to a number of REs associated with the number of RBs, wherein the DFT size is in accordance with a predefined format for a DFT size selection (block 730). For example, the transmitter (e.g., using communication manager 806, depicted in FIG. 8) may select a DFT size that is greater than or equal to a number of REs associated with the number of RBs, wherein the DFT size is in accordance with a predefined format for a DFT size selection, as described above.

As further shown in FIG. 7, in some aspects, process 700 may include puncturing one or more post-DFT symbols, wherein a quantity associated with the one or more post-DFT symbols is based at least in part on a difference between the DFT size and the number of REs (block 740). For example, the transmitter (e.g., using communication manager 806, depicted in FIG. 8) may puncture one or more post-DFT symbols, wherein a quantity associated with the one or more post-DFT symbols is based at least in part on a difference between the DFT size and the number of REs, as described above.

As further shown in FIG. 7, in some aspects, process 700 may include transmitting the DFT-s-OFDM transmission based at least in part on the puncturing (block 750). For example, the transmitter (e.g., using transmission component 804 or communication manager 806, depicted in FIG. 8) may transmit the DFT-s-OFDM transmission based at least in part on the puncturing, as described above.

Process 700 may include additional aspects, such as any single aspect or any combination of aspects described below or in connection with one or more other processes described elsewhere herein.

In a first aspect, process 700 includes applying a coding rate to obtain a number of coded constellation symbols, wherein the number of coded constellation symbols corresponds to the DFT size.

In a second aspect, alone or in combination with the first aspect, process 700 includes applying a DFT to the number of coded constellation symbols to obtain a plurality of post-DFT symbols, wherein the one or more post-DFT symbols that are punctured are selected from the plurality of post-DFT symbols, and the DFT is applied in accordance with the DFT size.

In a third aspect, alone or in combination with one or more of the first and second aspects, process 700 includes mapping a number of outputs to an IFFT for waveform generation, wherein the number of outputs corresponds to the number of REs.

In a fourth aspect, alone or in combination with one or more of the first through third aspects, the puncturing is applied to the plurality of post-DFT symbols to obtain a continuous set of non-punctured post-DFT symbols, wherein the puncturing is applied to one end of the plurality of post-DFT symbols or from two ends of the plurality of post-DFT symbols, and the one or more post-DFT symbols that are punctured are not transmitted.

In a fifth aspect, alone or in combination with one or more of the first through fourth aspects, the DFT size is selected such that the difference between the DFT size and the number of REs is smaller than differences between other possible DFT sizes and the number of REs.

In a sixth aspect, alone or in combination with one or more of the first through fifth aspects, the predefined format for the RB allocation restriction and the predefined format for the DFT size selection defines that the number of RBs or the number of REs is an integer multiple of 2, 3, or 5.

In a seventh aspect, alone or in combination with one or more of the first through sixth aspects, the predefined format for the RB allocation restriction and the predefined format for the DFT size selection defines that the number of RBs is of a form 2^{α}3^{β}5^{γ}, wherein α, β, and γ are non-negative integers.

In an eighth aspect, alone or in combination with one or more of the first through seventh aspects, the predefined format for the RB allocation restriction and the predefined format for the DFT size selection defines that the number of REs is of a form 12×2^{α}3^{β}5^{γ}, wherein α, β, and γ are non-negative integers.

In a ninth aspect, alone or in combination with one or more of the first through eighth aspects, the configuration excludes an RB allocation associated with a PAPR based metric or a cubic metric that satisfies a predefined threshold.

In a tenth aspect, alone or in combination with one or more of the first through ninth aspects, the configuration defines that the puncturing is to be applied for edge REs based at least in part on the DFT-s-OFDM transmission being associated with pulse shaping or frequency domain spectral shaping.

In an eleventh aspect, alone or in combination with one or more of the first through tenth aspects, the number of RBs is a flexible allocation of RBs for DFT-s-OFDM waveforms that is not restricted to being in accordance with the predefined format for the RB allocation restriction.

In a twelfth aspect, alone or in combination with one or more of the first through eleventh aspects, the transmitter is a UE or a network node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a transmitter, or a transmitter may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 or the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 or the processing system 145 described in connection with FIG. 1) of the transmitter.

In some aspects, the apparatus 800 may be configured to perform one or more operations described herein in connection with FIGS. 2-6. Additionally, or alternatively, the apparatus 800 may be configured to perform one or more processes described herein, such as process 700 of FIG. 7. In some aspects, the apparatus 800 or one or more components shown in FIG. 8 may include one or more components of the transmitter described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the transmitter described above in connection with FIG. 1, such as a radio, one or more RF chains, one or more transceivers, or one or more modems, each of which may in turn be coupled with one or more antennas of the transmitter.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive a configuration that indicates a number of RBs to be allocated for a DFT-s-OFDM transmission. The communication manager 806 may detect that the number of RBs is not in accordance with a predefined format for an RB allocation restriction. The communication manager 806 may select a DFT size that is greater than or equal to a number of REs associated with the number of RBs, wherein the DFT size is in accordance with a predefined format for a DFT size selection. The communication manager 806 may puncture one or more post-DFT symbols, wherein a quantity associated with the one or more post-DFT symbols is based at least in part on a difference between the DFT size and the number of REs. The transmission component 804 may transmit the DFT-s-OFDM transmission based at least in part on the puncturing.

The communication manager 806 may apply a coding rate to obtain a number of coded constellation symbols, wherein the number of coded constellation symbols corresponds to the DFT size. The communication manager 806 may apply a DFT to the number of coded constellation symbols to obtain a plurality of post-DFT symbols, wherein the one or more post-DFT symbols that are punctured are selected from the plurality of post-DFT symbols, and wherein the DFT is applied in accordance with the DFT size. The communication manager 806 may map a number of outputs to an inverse fast Fourier transform for waveform generation, wherein the number of outputs corresponds to the number of REs.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a transmitter, comprising: receiving a configuration that indicates a number of resource blocks (RBs) to be allocated for a discrete Fourier transform (DFT) spread orthogonal frequency division multiplexing (DFT-s-OFDM) transmission; detecting that the number of RBs is not in accordance with a predefined format for an RB allocation restriction; selecting a DFT size that is greater than or equal to a number of resource elements (REs) associated with the number of RBs, wherein the DFT size is in accordance with a predefined format for a DFT size selection; puncturing one or more post-DFT symbols, wherein a quantity associated with the one or more post-DFT symbols is based at least in part on a difference between the DFT size and the number of REs; and transmitting the DFT-s-OFDM transmission based at least in part on the puncturing.

Aspect 2: The method of Aspect 1, further comprising: applying a coding rate to obtain a number of coded constellation symbols, wherein the number of coded constellation symbols corresponds to the DFT size.

Aspect 3: The method of Aspect 2, further comprising: applying a DFT to the number of coded constellation symbols to obtain a plurality of post-DFT symbols, wherein the one or more post-DFT symbols that are punctured are selected from the plurality of post-DFT symbols, and wherein the DFT is applied in accordance with the DFT size.

Aspect 4: The method of Aspect 3, further comprising: mapping a number of outputs to an inverse fast Fourier transform for waveform generation, wherein the number of outputs corresponds to the number of REs.

Aspect 5: The method of Aspect 3, wherein the puncturing is applied to the plurality of post-DFT symbols to obtain a continuous set of non-punctured post-DFT symbols, wherein the puncturing is applied to one end of the plurality of post-DFT symbols or from two ends of the plurality of post-DFT symbols, and wherein the one or more post-DFT symbols that are punctured are not transmitted.

Aspect 6: The method of any of Aspects 1-5, wherein the DFT size is selected such that the difference between the DFT size and the number of REs is smaller than differences between other possible DFT sizes and the number of REs.

Aspect 7: The method of any of Aspects 1-6, wherein the predefined format for the RB allocation restriction and the predefined format for the DFT size selection defines that the number of RBs or the number of REs is an integer multiple of 2, 3, or 5.

Aspect 8: The method of any of Aspects 1-7, wherein the predefined format for the RB allocation restriction and the predefined format for the DFT size selection defines that the number of RBs is of a form 2^{α}3^{β}5^{γ}, wherein α, β, and γ are non-negative integers.

Aspect 9: The method of any of Aspects 1-8, wherein the predefined format for the RB allocation restriction and the predefined format for the DFT size selection defines that the number of REs is of a form 12×2^{α}3^{β}5^{γ}, wherein α, β, and γ are non-negative integers.

Aspect 10: The method of any of Aspects 1-9, wherein the configuration excludes an RB allocation associated with a PAPR based metric or a cubic metric that satisfies a predefined threshold.

Aspect 11: The method of any of Aspects 1-10, wherein the configuration defines that the puncturing is to be applied for edge REs based at least in part on the DFT-s-OFDM transmission being associated with pulse shaping or frequency domain spectral shaping.

Aspect 12: The method of any of Aspects 1-11, wherein the number of RBs is a flexible allocation of RBs for DFT-s-OFDM waveforms that is not restricted to being in accordance with the predefined format for the RB allocation restriction.

Aspect 13: The method of any of Aspects 1-12, wherein the transmitter is a user equipment or a network node.

Aspect 14: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-13.

Aspect 15: An apparatus for wireless communication at a device, the apparatus comprising one or more memories and one or more processors coupled to the one or more memories, the one or more processors configured to cause the device to perform the method of one or more of Aspects 1-13.

Aspect 16: An apparatus for wireless communication, the apparatus comprising at least one means for performing the method of one or more of Aspects 1-13.

Aspect 17: A non-transitory computer-readable medium storing code for wireless communication, the code comprising instructions executable by one or more processors to perform the method of one or more of Aspects 1-13.

Aspect 18: A non-transitory computer-readable medium storing a set of instructions for wireless communication, the set of instructions comprising one or more instructions that, when executed by one or more processors of a device, cause the device to perform the method of one or more of Aspects 1-13.

Aspect 19: A device for wireless communication, the device comprising a processing system that includes one or more processors and one or more memories coupled with the one or more processors, the processing system configured to cause the device to perform the method of one or more of Aspects 1-13.

Aspect 20: An apparatus for wireless communication at a device, the apparatus comprising one or more memories and one or more processors coupled to the one or more memories, the one or more processors individually or collectively configured to cause the device to perform the method of one or more of Aspects 1-13.

Aspect 21: A device comprising a processing system that includes one or more processors and one or more code-storing memories coupled with the one or more processors, the processing system configured to cause the device to perform the method of one or more of Aspects 1-13.

Aspect 22: A device comprising a processing system that includes processor circuitry and code-storing memory circuitry, the processing system configured to cause the device to perform the method of one or more of Aspects 1-13.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a transmitter, comprising:
one or more memories; and
one or more processors, coupled to the one or more memories, configured to cause the transmitter to:
receive a configuration that indicates a number of resource blocks (RBs) to be allocated for a discrete Fourier transform (DFT) spread orthogonal frequency division multiplexing (DFT-s-OFDM) transmission;
detect that the number of RBs is not in accordance with a predefined format for an RB allocation restriction;
select a DFT size that is greater than or equal to a number of resource elements (REs) associated with the number of RBs, wherein the DFT size is in accordance with a predefined format for a DFT size selection;
apply a puncturing to one or more post-DFT symbols, wherein a quantity associated with the one or more post-DFT symbols is based at least in part on a difference between the DFT size and the number of REs; and
transmit the DFT-s-OFDM transmission based at least in part on the puncturing.

2. The apparatus of claim 1, wherein the one or more processors are further configured to cause the transmitter to:
apply a coding rate to obtain a number of coded constellation symbols, wherein the number of coded constellation symbols corresponds to the DFT size.

3. The apparatus of claim 2, wherein the one or more processors are further configured to cause the transmitter to:
apply a DFT to the number of coded constellation symbols to obtain a plurality of post-DFT symbols, wherein the one or more post-DFT symbols that are punctured are selected from the plurality of post-DFT symbols, and wherein the DFT is applied in accordance with the DFT size.

4. The apparatus of claim 3, wherein the one or more processors are further configured to cause the transmitter to:
map a number of outputs to an inverse fast Fourier transform for waveform generation, wherein the number of outputs corresponds to the number of REs.

5. The apparatus of claim 3, wherein the puncturing is applied to the plurality of post-DFT symbols to obtain a continuous set of non-punctured post-DFT symbols, wherein the puncturing is applied to one end of the plurality of post-DFT symbols or from two ends of the plurality of post-DFT symbols, and wherein the one or more post-DFT symbols that are punctured are not transmitted.

6. The apparatus of claim 1, wherein the DFT size is selected such that the difference between the DFT size and the number of REs is smaller than differences between other possible DFT sizes and the number of REs.

7. The apparatus of claim 1, wherein the predefined format for the RB allocation restriction and the predefined format for the DFT size selection defines that the number of RBs or the number of REs is an integer multiple of 2, 3, or 5.

8. The apparatus of claim 1, wherein the predefined format for the RB allocation restriction and the predefined format for the DFT size selection defines that the number of RBs is of a form 2^{α}3^{β}5^{γ}, wherein α, β, and γ are non-negative integers.

9. The apparatus of claim 1, wherein the predefined format for the RB allocation restriction and the predefined format for the DFT size selection defines that the number of REs is of a form 12×2^{α}3^{β}5^{γ}, wherein α, β, and γ are non-negative integers.

10. The apparatus of claim 1, wherein the configuration excludes an RB allocation associated with a PAPR based metric or a cubic metric that satisfies a predefined threshold.

11. The apparatus of claim 1, wherein the configuration defines that the puncturing is to be applied for edge REs based at least in part on the DFT-s-OFDM transmission being associated with pulse shaping or frequency domain spectral shaping.

12. The apparatus of claim 1, wherein the number of RBs is a flexible allocation of RBs for DFT-s-OFDM waveforms that is not restricted to being in accordance with the predefined format for the RB allocation restriction.

13. The apparatus of claim 1, wherein the transmitter is a user equipment or a network node.

14. A method of wireless communication performed by a transmitter, comprising:
receiving a configuration that indicates a number of resource blocks (RBs) to be allocated for a discrete Fourier transform (DFT) spread orthogonal frequency division multiplexing (DFT-s-OFDM) transmission;
detecting that the number of RBs is not in accordance with a predefined format for an RB allocation restriction;
selecting a DFT size that is greater than or equal to a number of resource elements (REs) associated with the number of RBs, wherein the DFT size is in accordance with a predefined format for a DFT size selection;
puncturing one or more post-DFT symbols, wherein a quantity associated with the one or more post-DFT symbols is based at least in part on a difference between the DFT size and the number of REs; and
transmitting the DFT-s-OFDM transmission based at least in part on the puncturing.

15. The method of claim 14, further comprising:
applying a coding rate to obtain a number of coded constellation symbols, wherein the number of coded constellation symbols corresponds to the DFT size; and
applying a DFT to the number of coded constellation symbols to obtain a plurality of post-DFT symbols, wherein the one or more post-DFT symbols that are punctured are selected from the plurality of post-DFT symbols, and wherein the DFT is applied in accordance with the DFT size.

16. The method of claim 15, further comprising:
mapping a number of outputs to an inverse fast Fourier transform for waveform generation, wherein the number of outputs corresponds to the number of REs.

17. The method of claim 15, wherein the puncturing is applied to the plurality of post-DFT symbols to obtain a continuous set of non-punctured post-DFT symbols, wherein the puncturing is applied to one end of the plurality of post-DFT symbols or from two ends of the plurality of post-DFT symbols, and wherein the one or more post-DFT symbols that are punctured are not transmitted.

18. The method of claim 14, wherein the DFT size is selected such that the difference between the DFT size and the number of REs is smaller than differences between other possible DFT sizes and the number of REs.

19. The method of claim 14, wherein the predefined format for the RB allocation restriction and the predefined format for the DFT size selection defines that the number of RBs is of a form 2^{α}3^{β}5^{γ} or of a form 12×2^{α}3^{β}5^{γ}, wherein α, β, and γ are non-negative integers.

20. A non-transitory computer-readable medium storing a set of instructions for wireless communication, the set of instructions comprising:
one or more instructions that, when executed by one or more processors of a transmitter, cause the transmitter to:
receive a configuration that indicates a number of resource blocks (RBs) to be allocated for a discrete Fourier transform (DFT) spread orthogonal frequency division multiplexing (DFT-s-OFDM) transmission;
detect that the number of RBs is not in accordance with a predefined format for an RB allocation restriction;
select a DFT size that is greater than or equal to a number of resource elements (REs) associated with the number of RBs, wherein the DFT size is in accordance with a predefined format for a DFT size selection;
puncture one or more post-DFT symbols, wherein a quantity associated with the one or more post-DFT symbols is based at least in part on a difference between the DFT size and the number of REs; and
transmit the DFT-s-OFDM transmission based at least in part on the puncturing.
